(19) United States
(12) Patent Application Publication
(10) Pub. No.: US 2012/0320812 A1
(43) Pub. Date: Dec. 20, 2012

(54) Method for Associating Time Slots with Links Between Network Nodes of a Wireless Interconnected Network

(75) Inventor: Andreas Heinrich, Muenchen (DE)

(73) Assignee: SIEMENS AKTIENGESELLSCHAFT, Muenchen (DE)

(21) Appl. No.: 13/574,597

(22) PCT Filed: Jan. 19, 2011
(86) PCT No.: PCT/EP2011/050644

§ 371 Date: Jul. 20, 2012

(30) Foreign Application Priority Data
Jan. 22, 2010 (EP) 10000625.3

(51) Int. Cl. H04W 72/12; H04W 52/02

(52) U.S. Cl. 370/311; 370/345

(57) ABSTRACT

A method for associating time slots with links between network nodes of a wireless interconnected network, the data in the network being transmittable from a source node to a destination node on a time slot basis by association via hops or corresponding hop levels, wherein a main path having one network node per hop level and the corresponding links between the network nodes of adjacent hop levels is set from the source node to the destination node, and alternative network nodes having corresponding alternative links, which can be used in place of the main path for data transmission, are also set.

### CROSS-REFERENCE TO RELATED APPLICATIONS

This is a U.S. national stage of international application No. PCT/EP2011/050644 filed 19 Jan. 2011. Priority is claimed on European Application No. 10000625.3 filed 22 Jan. 2010, the content of which is incorporated herein by reference in its entirety.

### BACKGROUND OF THE INVENTION

1. Field of the Invention

The invention relates to a method for associating time slots to links between network nodes of a wireless interconnected network and a method for the transmission of data using the method for associating time slots. The invention also relates to a network management unit and a wireless interconnected network.

2. Description of the Related Art

Wireless interconnected networks, which are frequently also known as mesh networks, are based on the principle that data is transmitted through a plurality of intercommunicating network nodes with wireless communication functions from one network node to another by “hops” (i.e., forwarding by other nodes). In such cases, the networks are structured such that the range of a network node encompasses several other network nodes to which data can be sent. The transmission of data in mesh networks is performed using scheduling methods with which time slots are associated with corresponding links between two network nodes, in which time slots the link can be used for the transmission of data. Here, data transmission as a rule occurs by a plurality of transmission frequencies, hereinafter also called channels, where a plurality of links with different start and end nodes can be used in one time slot on different channels for disjunct links with different start and end nodes.

At present, reliable data transmission in wireless interconnected networks is ensured by scheduling methods with which time slots are associated with corresponding links for data transmission over as many channels as possible. This has the drawback that the individual network nodes are frequently activated for listening or transmission in the corresponding time slots. If, for example, the wireless interconnected network is a sensor network with battery-operated sensors, this results in a reduced operating time of the sensors, because listening in the channels results in high energy consumption thus making it necessary to change the sensor batteries at short time intervals.

### SUMMARY OF THE INVENTION

It is therefore an object of the invention to organize the association of time slots with links between network nodes of a wireless interconnected network such that, during data transmission, more energy-efficient operation of the network nodes is ensured while still retaining good reliability of data transmission.

This and other objects and advantages are achieved in accordance with the invention by providing a method in which time slots are associated with links between network nodes of a wireless interconnected network comprising a plurality of wirelessly communicating network nodes, where data and in particular data packets in the network are to be transmitted on a time slot basis by the association of time slots to be used for data transmission on one or more channels with the links between a source node and a target node. This means that the data transmission uses a suitably defined association of time slots so that, during data transmission in a corresponding time slot and a corresponding channel, exclusively data for the link defined by the association can be transmitted. Here, it should be taken into account that, in one time slot, data can be transmitted over a plurality of channels (if available) simultaneously so that one time slot can be used simultaneously for a plurality of links subject to the constraint that links used in the same time slot are disjunct and have different start and target nodes. This takes into account the fact that, during wireless transmission, one network node per time slot is only able to transmit or receive data on one channel. The association of time slots with links in accordance with the invention is used for multi-hop transmission, where, for data transmission between the source node and the target node, a predetermined number of successive hop levels is set. In addition, for each hop level, there is a plurality of network nodes through which data can be routed from the source node to the target node. This is a suitable way of establishing how many nodes should be used in a hop level between a source node and target node for data transmission, where it is always necessary to ensure that the corresponding nodes of adjacent hop levels are within range of each other.

In accordance with the method of the invention, in a step a), a main path having in each case one network node per hop level and the corresponding links between the network nodes of adjacent (i.e., directly successive) hop levels is set from the source node to the target node. Hence, a link is a directed transmission route between one hop level to the next hop level in the sequence of the hop levels. In addition, in a step b), for the hop levels between source node and target node, in each case a number of alternative network nodes, which do not belong to the main path, from the plurality of network nodes of the respective hop levels are set, where a respective alternative network node is associated with an alternative link between the network nodes of the main path in the preceding hop level and the respective alternative network nodes and with an alternative link between the respective alternative network node and the network nodes of the main path in the next hop level.

In accordance with the invention, in a step c), the links of the main path and the alternative links are then associated with time slots such that an alternative link extending from a respective network node receives a temporally later time slot than the link of the main path extending from the respective network node. Here, this first criterion relates to network nodes of the main path. According to a second criterion relating to both network nodes of the main path and alternative network nodes, links entering a respective network node receive temporally earlier time slots than links extending from the respective network node.

The method in accordance with the invention is characterized in that, starting from data transmission over a main path, alternative paths are set in a suitable way. This ensures that preference is given to the main path during the association of the time slots according to the first criterion. In addition, the second criterion ensures that the data is routed sequentially between the source node and the target node via the corresponding hop levels. A suitable setting of a main path (for example, based on the criterion of a lowest possible data error rate) and a corresponding number of alternative links can, on the one hand, achieve reliable data transmission. On the other hand, the scheduling defined in accordance with the invention limits the number of transmission possibilities via corresponding links so that the number of time slots not used for transmission is reduced and hence much more energy-efficient data transmission is facilitated with comparable reliability to that of conventional methods.

In a preferred embodiment, the time slot association defined in inventive step c) defined is implemented based on the following specification:

i) for a respective network node of the main path, each alternative link entering the respective network node receives a temporally earlier time slot than the link of the main path extending from the respective network node;

ii) for a respective network node of the main path, the alternative link extending from the respective network node receives a temporally later time slot than the link of the main path extending from the respective network node; and

iii) for a respective alternative network node, the alternative link entering the respective alternative network node receives a temporally earlier time slot than the alternative link extending from the respective alternative network nodes.

As mentioned above, high reliability of data transmission is achieved, particularly based on a criterion according to which the main path or the links thereof have the lowest possible data error rate and/or the highest possible reliability/link stability during data transmission and/or best possible energy efficiency during data transmission. The establishment of a criterion of this kind is within the capacity of the person skilled in the art. In a further embodiment, a corresponding criterion is also established for the alternative network nodes. This means that the alternative network nodes are preferably selected such that the alternative links thereof have the lowest possible data error rate and/or the highest possible reliability/link stability during data transmission and/or the best possible energy efficiency during data transmission.

The number of the alternative network nodes used for purposes of the disclosed embodiments of the method of the invention can vary according to the application in question. If the emphasis is on particularly energy-efficient operation of the network, in a preferred embodiment, a single alternative network node is set for at least one hop level and in particular for all hop levels. If the emphasis is on reliability of data transmission, in a further embodiment, a plurality of alternative network nodes can be set for at least one and in particular for all hop levels.

In a further preferred embodiment of the invention, for a respective hop level, the alternative network nodes are sorted in a temporal sequence according to which the alternative network nodes with their alternative links are associated with the time slots. This enables further criteria to be considered during the association of time slots with alternative network nodes, such as the data error rate over the alternative links, by the corresponding establishment of this temporal sequence. Here, during the time slot association, alternative nodes with alternative links with a lower data error rate should be considered initially and only subsequently alternative network nodes with higher data error rates.

In a further embodiment of the invention, in addition to the links of the main path and the alternative links, additional links between alternative network nodes of adjacent hop levels are also considered. Here, for at least one pair of adjacent hop levels, in each case at least one additional link is set between alternative network nodes of the adjacent hop levels, where an alternative link extending from an alternative network node receives a temporally earlier time slot than each additional link extending from the alternative network node.

In a further embodiment of the method in accordance with the invention, the respective links can be associated with time slots with variable lengths. Here, it is possible, for example, to set a fixed time slot length, where, to extend the length of a time slot, a plurality of slots with this fixed time slot length can be associated successively with the same link.

As mentioned above, the method in accordance with the disclosed embodiments is characterized by energy-efficient operation of the network. Accordingly, the method is preferably embodied in an interconnected network comprising a wireless sensor network, in which the network nodes are at least partially sensors with an autonomous energy supply, such as battery-operated sensors. Nevertheless, the disclosed embodiments of the method can also be used in sensor networks in which the sensors are not subject to any energy restrictions.

In addition to the above described method for the association of time slots with links between network nodes in an interconnected network, the invention also relates to a method resulting therefrom for time-slot-based data transmission in a wirelessly interconnected network with a plurality of network nodes. Here, time slots are associated with links between a source node and a target node according to the above-described embodiments of the method in accordance with the invention, where, based on this association between the source node and the target node, data are transmitted on one or more channels. The disclosed embodiments of the method in accordance with the invention can be combined with a data transmission method which is known per se, such as with the standards WirelessHART, Institute of Electrical and Electronic Engineers (IEEE) 805.15.4e or Industry Standard Architecture (ISA) 100.11a known from the prior art. Here, it is only necessary to implement the association of the time slots with network nodes in a network management unit, for example.

It is also an object to provide a network management unit for a wireless interconnected network comprising a plurality of wirelessly intercommunicating network nodes, where the network management unit is configured to associate time slots with links between network nodes based on the above-described associating method in accordance with the disclosed embodiments of the invention.

It is also an object to provide a wireless interconnected network comprising a plurality of wirelessly intercommunicating network nodes with a network management unit of this kind. The network nodes and the network management unit are hereby configured such that they are able to transmit data based on the above-described disclosed embodiments of the transmission method in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments off the invention are described below in detail with reference to the attached figures, in which:

FIG. 1 to FIG. 3 are schematic representations illustrating the use of links between network nodes of a mesh network based on different exemplary embodiments of the method in accordance with the invention;

FIG. 4 is a schematic representation of a mesh network in which an embodiment of the method in accordance with the invention has been implemented;

FIG. 5 is a schematic block diagram illustrating the association of time slots with links for the mesh network in FIG. 4 based on the method in accordance with the invention; and

FIG. 6 is a flowchart of the method in accordance with an embodiment of the invention.

### DETAILED DESCRIPTION OF THE PREFERRED EMBODIMENTS

The following describes exemplary embodiments of the method according to the invention for a multi-hop mesh network in which data packets are transmitted on a time-slot basis with a suitable standard, such as WirelessHART. Here, the method in accordance with the invention represents a new association of time slots with corresponding wireless links between network nodes, where, in addition to the highest possible reliability of transmission, the most energy-efficient usage of the network nodes is ensured. Here, the method is in particular suitable for use in sensor networks, in which at least a part of the network nodes are sensors, which as a rule have an autonomous energy supply (for example, a battery). In such networks, data is not transmitted continuously from a source node to a target node, but there are frequently lengthy pauses in transmission until a corresponding sensor has again identified new sensor data, which it wishes to make available to other network nodes. To operate the sensors as energy efficiently as possible, it is desirable for the sensors not to wait unnecessarily frequently in corresponding time slots for a data transmission when the data transmission is not occurring. This is due to the fact that, when waiting for the data transmission, the corresponding sensors listen in the radio channel and hence use more energy that would be contrary to the objective of lowest possible energy consumption.

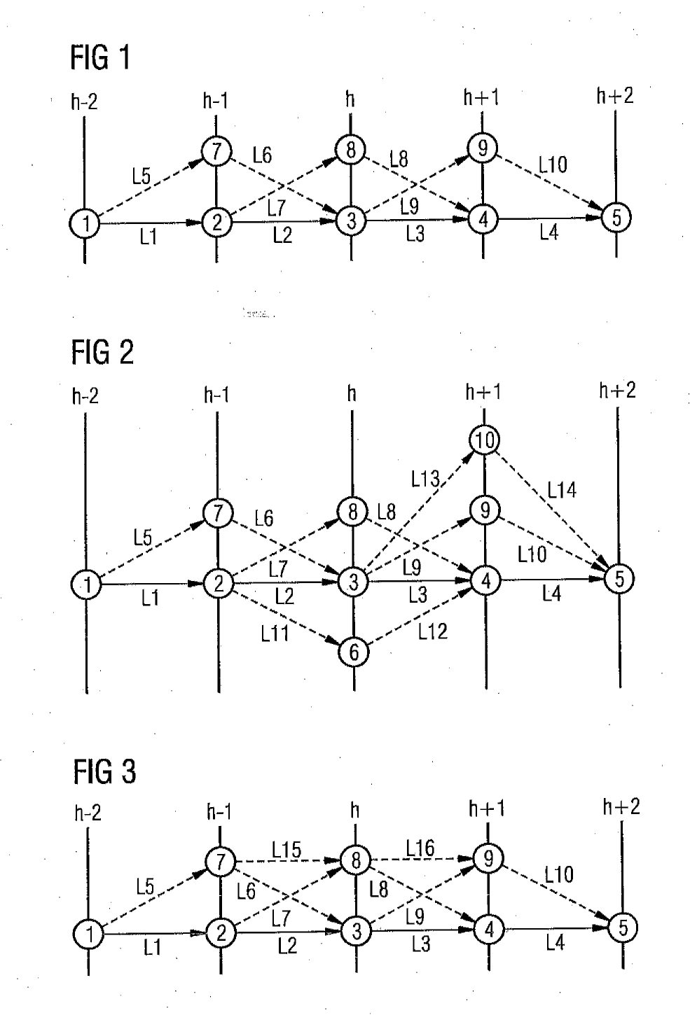

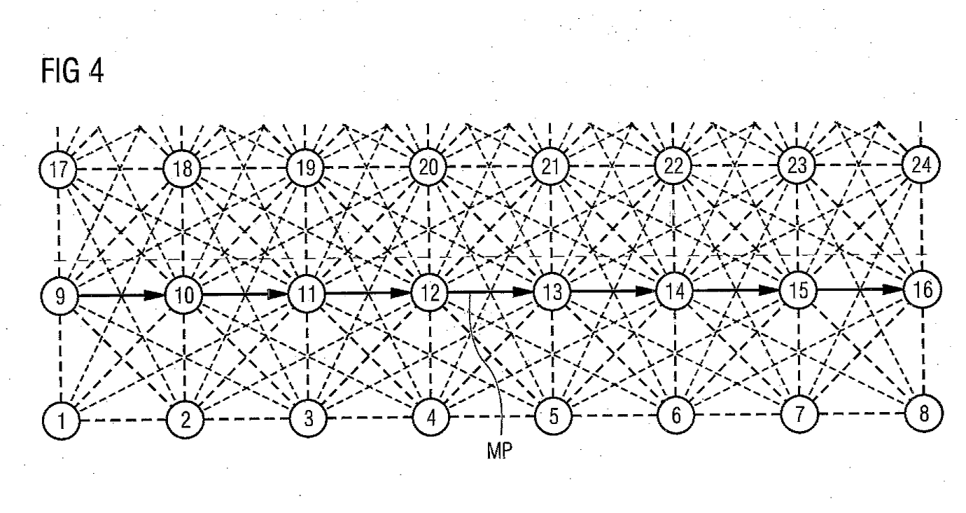

Before embodiments of the method in accordance with the invention are explained with reference to FIG. 1 to FIG. 3, there will first be an explanation of FIG. 4 which shows by way of example a section of a multi-hop mesh network. A total of 24 network nodes 1, 2, 3, . . . , 24 of this network are shown. Dashed lines also indicate possible links forming direct communication paths between network nodes within range of each other. However, during the multi-hop data transmission from network node 9 to network node 16, only the thicker dashed lines between the network nodes in FIG. 4 are used. Here, the individual columns in the network in FIG. 4, which in each case comprise three of the nodes shown, result in the formation of corresponding hop levels of the hop-based transmission, where the hop levels between the source node 9 and the target node 16 are numbered in sequence and the transfer of data packets always occurs from a corresponding network node in one hop level to a following network node in the next hop level according to the numbering.

In the method in accordance with the invention, a main path for data transmission from a source node to a target node is initially set. In FIG. 4, a main path of this kind is designated MP and indicated by corresponding arrows. It is evident that, starting from node 9, the main path extends horizontally via the nodes 10, 11, . . . , 15 to the target node 16. The main path can be set suitably according to the type of application in question. Preferably, the path is selected such that the packet error rate on the main path is low compared to other paths.

In the method in accordance with the invention, in addition to the main path, corresponding alternative paths with alternative links via further network nodes are also defined to ensure data transmission via other links in the event of a packet loss on the main path. Here, a corresponding scheduling method is defined, which is implemented such that transmission along the main path is preferred over other transmission routes and which also ensures sequential multi-hop transmission from the source node to the target node.

FIG. 1 to FIG. 3 show different embodiments taking into account alternative paths with reference to network nodes 1, 2, . . . , 10 of a wireless interconnected network. Here, it should be noted that the numbering of the network nodes in FIG. 1 to FIG. 3 bears no correlation to the mesh network in FIG. 4. FIG. 1 to FIG. 3 show a section of a multi-hop network with correspondingly usable links. Here, once again, a main path is set for data transmission between a source node and a target node, where the path extends via the network nodes 1, 2, 3, 4 and 5 and comprises the links L1, L2, L3 and L4. Generally, the main path between a source node aᵢ and a target node aⱼ is described as a subgraph in the network comprising a set of network nodes Nₘₐᵢₙ and a set of links

Lₘₐᵢₙ [symbol] {lᵢⱼ:i,j ∈Nₘₐᵢₙ}.

In accordance with the invention, alternative network nodes with ingoing and outgoing alternative links for the individual hop levels lying between the source node and the target node are now set; in FIG. 1 to FIG. 3, these are designated h−2, h1, h, h+1 and h+2. In particular, a number of alternative 2-hop paths (1_{i,a}, 1_{a,k}) are defined for each 2-hop segment (1_{i,j}, 1_{j,k}) on the main path using a number of alternative network nodes which are adjacent to the end nodes of the corresponding 2-hop segments of the main path. Here, an adjacent network node is a network node set for the 2-hop segment or the middle hop level of this segment, via which data packets can also be routed during the multi-hop transmission. The number of adjacent network nodes can be described in accordance with the relationship:

N_{neigh}={a:∃a ∈ Nᵢ und a ∈ Nₖ und a ∉ Nₘₐᵢₙ}.

Here, Nᵢ designates network nodes that are adjacent to network nodes of the hop level i of the main path. Similarly, Nₖ designates network nodes that are adjacent to the network node of the hop level k of the main path. The number of adjacent network nodes from the quantity N_{neigh} are designated Hence, a node in the main path in the hop level i comprises |N_{neigh}| alternative paths for the transmission of data packets to the node of the main path in the hop level k.

FIG. 1 shows an embodiment of the method in accordance with the invention with which only one alternative 2-hop segment is always defined for the corresponding 2-hop segments. This is due to the fact that, for the hop levels h−1, h and h+1, only one single alternative network node 7, 8 or 9 is set via which data can be transmitted by corresponding alternative links. Here, in FIG. 1, the links for alternative use are designated L5, L6 for the alternative network node 7, L7 and L8 for the alternative network node 8 and L9 and L10 for the alternative network node 9.

In a modification of the method in FIG. 1, which is shown in FIG. 2, a plurality of alternative paths, and hence a plurality of alternative network nodes, are at least partially provided for data transmission for corresponding 2-hop segments. This increases the reliability of the data transmission. It is evident from FIG. 2 that, for the hop level h, additionally to the alternative network node 8, the network node 6 is provided, where data transmission can also occur via the further alternative links L11 and L12. Similarly, for the hop level h+1, additionally to the network node 9, the network node 10 is provided, where data transmission can also occur via this network node by the alternative links L13 and L14.

FIG. 3 shows a further modification of the method in FIG. 1, with which, in addition, data transmission is permitted directly between alternative network nodes. To this end, in the example in FIG. 3, the additional links L15 and L16 are provided with which data packets can be transferred between the network nodes 7 and 8 or the network nodes 8 and 9. The method in FIG. 3 can optionally also be combined with the method in FIG. 2, i.e., it is also possible for more than one alternative network node for data transmission to be provided for each hop level.

The establishment of a corresponding main path and alternative network node and links can be performed based on different metrics. Preferably, in the event of the packet loss rates of the links in the network being known, a route is set for the main path that results in a minimal end-to-end packet error rate and hence in highest reliability with a simultaneously low energy consumption of the network nodes. Similarly, the alternative links used for data transmission can be selected such that they have the lowest error rate of all possible usable links. In addition, alternative network nodes to be used can be suitably sorted so that, during the association of the time slots, initially alternative network nodes are considered which result in the lowest packet error rate compared to the other alternative network nodes.

On the basis of the links of the main path and alternative links in accordance with the invention defined with reference to FIG. 1 to FIG. 3, a suitable strategy for the association of the corresponding time slots during the time-slot based transmission of data via the links is determined. This strategy ensures sequential routing of the data packets between the source node and the target node from one hop level to the next, where, in addition, during data transmission, links on the main path are preferred to corresponding alternative links.

In a particularly preferred embodiment, the method for associating the time slots to corresponding links of the main path or the alternative links is implemented based on the following specification:
A node on the main path in the hop level h must associate a temporally earlier time slot with each alternative link entering in the node from the hop level h−1 than that associated with the link of the main path extending from the node to the hop level h+1.
A node on the main path in the hop level h must associate a temporally later time slot with each alternative link extending from the node to the hop level h+1 than that associated with the link of the main path extending from the node to the hop level h+1.
An alternative network node in the hop level h must associate a temporally earlier time slot with each link from the hop level h−1 entering the alternative network node than that associated with the alternative link extending from the alternative network node to the hop level h+1.

The sequence, in which, the corresponding alternative neighboring nodes N_{neigh} with their alternative links are considered during the association of the time slots with the links can be set as desired. In a preferred embodiment, the alternative network nodes are suitably sorted, for example, based on a list. In this case, the sequence of the nodes in N_{neigh} sets the sequence in which alternative paths are associated with corresponding time slots. When N_{neigh} is sorted for the hop level h+1, the network node on the main path in the hop level has to sort time slots for alternative links extending from this node in the same sequence. This means the first choice of alternative network nodes set according to the sequence has to be taken into account during the association of time slots before the second choice of the alternative network nodes etc.

In the event of additional links based on the variant in FIG. 3 being considered for the associated of time slots, the above specification has to be expanded by the following rule:
An alternative link from one network node in the hop level h to the network node of the main path in the hop level h+1 receives a temporally earlier time slot than each additional link to an alternative network node of the hop level h+1.

The above-defined temporal association of corresponding time slots with links is repeated continuously following completion of a cycle from the source node to the target node. In addition, as a rule, the associated of time slots is performed for a plurality of channels or channel offsets to be used during the wireless data transmission, where data on links with disjunct start and end nodes can be transmitted in parallel in each channel. Usually, the time slots assigned for data transmission are always of the same length. However, it is also optionally possible for the time slots for corresponding links to have variable lengths. This is achieved in that, for data transmission with a longer time slot, a plurality of predetermined time slots with a predetermined length are associated in sequence with the corresponding link.

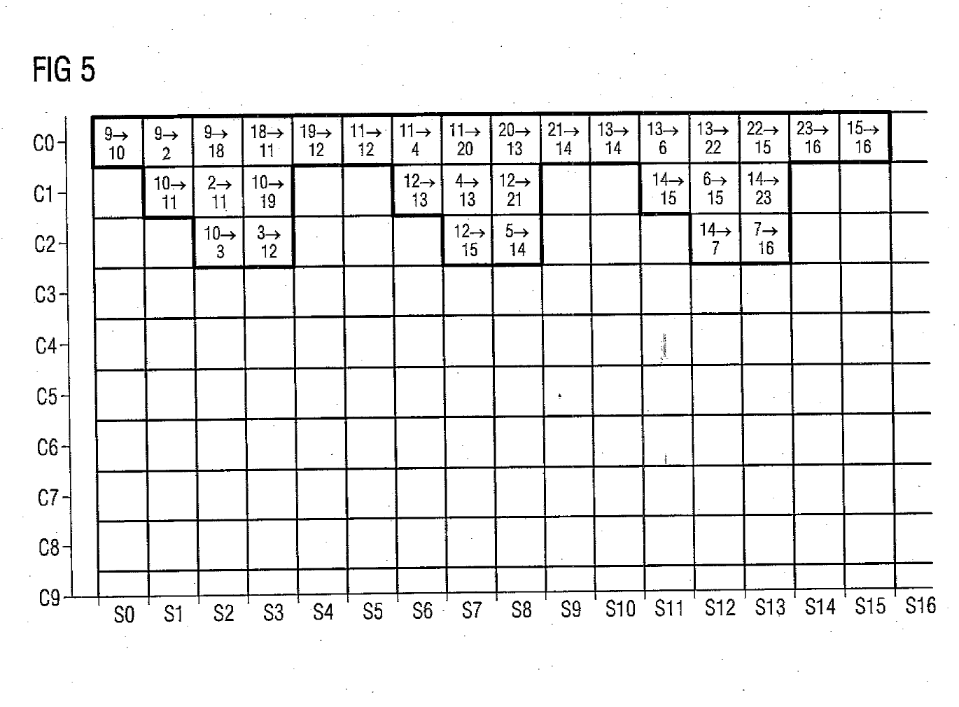

FIG. 5 is a schematic block diagram showing time slots S0, S1, . . . , S16 along its horizontal axis and the corresponding channels to use C0, C1, . . . , C9 along its perpendicular axis. This depicts the data transmission between the source node 9 and the target node 16 in FIG. 4. This is an implementation of an embodiment of the method in which, for the data transmission, in addition to the network node of the main path MP, two alternative network nodes per hop level were considered. This means the further, network nodes 2 and 18 shown in FIG. 4 with corresponding alternative links were considered for the hop level with the network nodes 10, the two alternative network nodes 3 and 19 with the corresponding alternative links were considered for the hop level with the network nodes 11 and so forth.

FIG. 5 indicates for the individual time slots the corresponding links to be used in these time slots for data transmission by the numbers of the start and target nodes of the links with an arrow between them. For example, for the time slot S2, data transmission is possible in the three channels C0, C1 and C2, where in the channel C0, data transmission is permitted between nodes 9 and 18, in the channel C1, data transmission is permitted between nodes 2 and 11 and in the channel C2, data transmission is permitted between nodes 10 and 3. Contrary to conventional methods, during data transmission only a small subset of three of the total of 10 channels available is used. This ensures that the individual network nodes are not activated too frequently to listen in a channel and hence consume little energy. Nevertheless, the definition of corresponding alternative network nodes and alternative links achieves very reliable data transmission.

The disclosed embodiments of the invention as described above have several advantages. The establishment of alternative paths starting from a main path achieves a path system with little complexity together with high reliability. Here, the association of the time slots is energy-efficient because the number of unused time slots is greatly reduced. This is in particular advantageous in sensor networks with battery-operated sensors because data packets are not transmitted continuously in such networks and energy-efficient operation of the sensors is of high priority. In accordance with the invention, the use of links is concentrated on a corresponding set main path. This has the advantage that, during data transmission, particularly reliable network nodes can be set for the main path. In addition, it is possible to establish the use of alternative links by sorting the alternative network nodes.

Hence, in accordance with the disclosed embodiments of the invention, the main data traffic is transmitted along the main path and the alternative network nodes are then used if nodes of the main path fall out or cannot be reached. Here, it is possible, for example, to achieve energy-efficient usage of network nodes with energy restriction (for example, network nodes with an autonomous energy supply or battery) in that data traffic is mainly routed via such network nodes with no energy restrictions and to be precise in that the main path is formed by network nodes without energy restrictions and network nodes with energy restrictions are used as alternative network nodes.

Even if, in the disclosed embodiments of the method in accordance with the invention, the delay in the transmission of data packets can be higher than with conventional methods, the distribution of possible time delays is lower and data transmission with high reliability is still achieved. In preferred embodiments, there is also a possibility of optimizing the association of the time slots based on corresponding link metrics, i.e., based on the lowest possible data packet error rate.

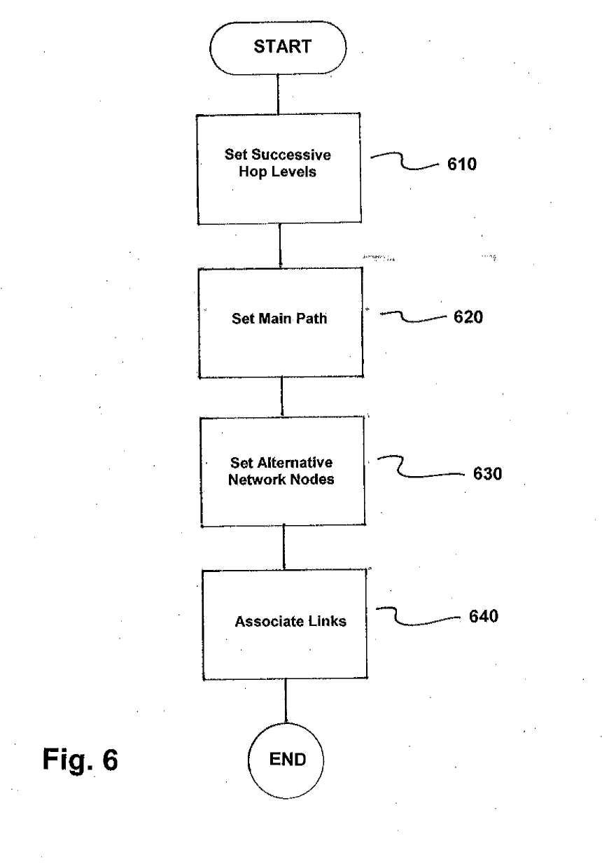

FIG. 6 depicts a method for associating time slots with links between network nodes of a wireless interconnected network including a plurality of wirelessly communicating network nodes, where data in the network is transmitted on a time slot basis by the association of the time slots to be used for data transmission with the links between a source node and a target node of the plurality of network nodes on at least one channel by a plurality of hops. The method comprises setting a predetermined number of successive hop levels for the data transmission between the source node and the target node, as indicated in step 610. In accordance with the method of the invention, a plurality of the network nodes via which data is routable from the source node to the target node is provided for each hop level.

A main path having one network node per hop level and corresponding links between the network nodes of adjacent hop levels from the source node to the target node is set, as indicated in step 620.

Next, each of a number of alternative network nodes of the plurality of network nodes, which do not belong to the main path, from the plurality of network nodes of respective hop levels for the hop levels between source nodes and target nodes are set, as indicated in step 630. In accordance with the method of the invention, a respective alternative network node is associated with an alternative link from the network node of the main path in a preceding hop level to the respective alternative network node and is associated with an alternative link from the respective alternative network node to the network node of the main path in the next hop level.

Links of the main path and alternative links are now associated with the time slots such that an alternative link extending from a respective network node receives a temporally later time slot than a link of the main path extending from the respective network node and such that links entering a respective network node receive temporally earlier time slots than links extending from the respective network node, as indicated in step 640.

While there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. A method for associating time slots with links between network nodes of a wireless interconnected network comprising a plurality of wirelessly communicating network nodes, wherein data in the network is to be transmitted on a time slot basis by the association of the time slots to be used for data transmission with the links between a source node and a target node of the plurality of network nodes on at least one channel by a plurality of hops, the method comprising:
aa) setting a predetermined number of successive hop levels for the data transmission between the source node and the target node, a plurality of the network nodes via which data is routable from the source node to the target node being provided for each hop level;
a) setting a main path having one network node per hop level and corresponding links between the network nodes of adjacent hop levels from the source node to the target node;
b) setting each of a number of alternative network nodes of the plurality of network nodes, which do not belong to the main path, from the plurality of network nodes of respective hop levels for the hop levels between source nodes and targets node, a respective alternative network node being associated with an alternative link from the network node of the main path in a preceding hop level to the respective alternative network node and being associated with an alternative link from the respective alternative network node to the network node of the main path in the next hop level; and
c) associating links of the main path and alternative links with the time slots such that an alternative link extending from a respective network node receives a temporally later time slot than a link of the main path extending from the respective network node and such that links entering a respective network node receive temporally earlier time slots than links extending from the respective network node.

16. The method as claimed in claim 15, wherein the association of the time slots in step c) occurs based on a following specification:
i) for a respective network node of the main path, each alternative link entering the respective network node receives a temporally earlier time slot than the link of the main path extending from the respective network node;
ii) for a respective network node of the main path, each alternative link extending from the respective network node receives a temporally later time slot than the link of the main path extending from the respective network node; and
iii) for a respective alternative network node, the alternative link entering the respective alternative network node receives a temporally earlier time slot than the alternative link extending from the respective alternative network nodes.

17. The method as claimed in claim 15, wherein the main path is set based on at least one of a criterion, a highest possible reliability of the data transmission, and a best possible energy efficiency of the data transmission and the lowest possible data error rate.

18. The method as claimed in claim 16, wherein the main path is set based on at least one of a criterion, a highest possible reliability of the data transmission, and a best possible energy efficiency of the data transmission and the lowest possible data error rate.

19. The method as claimed in claim 15, wherein the alternative network nodes are set such that their alternative links have at least one of a lowest possible data error rate, a highest possible reliability during the data transmission and a best possible energy efficiency during the data transmission.

20. The method as claimed in claim 15, wherein a single alternative network node is set for at least one hop level.

21. The method as claimed in claim 20, wherein the single alternative network node is set for all hop levels.

22. The method as claimed in claim 15, wherein a plurality of the alternative network nodes are set for at least one level.

23. The method as claimed in claim 22, wherein the plurality of alternative network nodes are set for all hop levels

24. The method as claimed in claim 15, wherein, for a respective hop level, the alternative network nodes are sorted in a temporal sequence according to which alternative network nodes with their alternative links are associated with the time slots.

25. The method as claimed in claim 15, wherein, for at least one pair of adjacent hop levels, at least one additional link of each of the at least one pair of adjacent hop levels is set between alternative network nodes of the adjacent hop levels; and wherein an alternative link extending from an alternative network node receives a temporally earlier time slot than each additional link extending from the alternative network node.

26. The method as claimed in claim 15, wherein the respective links are associated with variable length time slots.

27. The method as claimed in claim 15, wherein the interconnected network comprises a wireless sensor network in which the network nodes at least partially represent sensors.

28. The method as claimed in claim 27, wherein the sensors include an autonomous energy supply.

29. A method for time-slot based data transmission in a wireless interconnected network with a plurality of network nodes, wherein time slots are associated with links between a source node and a target node based on the method as claimed in claim 1 and the data are transmitted on the at least one channel based on the association between the source node and the target node.

30. The method as claimed in claim 28, wherein the data transmission is in accordance with one of a WirelessHART standard, an Institute of Electrical and Electronic Engineers standard 802.15.4 and an Industry Standard Architecture standard 100.11a.

31. A network management unit for a wireless interconnected network, comprising:
a plurality of network nodes communicating wirelessly with each other;
wherein the network management unit is configured to associate time slots with links between each of the plurality of network nodes by:
aa) setting a predetermined number of successive hop levels for the data transmission between the source node and the target node of the plurality of network nodes, a plurality of the network nodes via which data is routable from the source node to the target node being provided for each hop level;
a) setting a main path having one network node per hop level and corresponding links between the network nodes of adjacent hop levels from the source node to the target node;
b) setting each of a number of alternative network nodes of the plurality of network nodes, which do not belong to the main path, from the plurality of network nodes of respective hop levels for the hop levels between source nodes and targets node, a respective alternative network node being associated with an alternative link from the network node of the main path in a preceding hop level to the respective alternative network node and being associated with an alternative link from the respective alternative network node to the network node of the main path in the next hop level; and
c) associating links of the main path and alternative links with the time slots such that an alternative link extending from a respective network node receives a temporally later time slot than a link of the main path extending from the respective network node and such that links entering a respective network node receive temporally earlier time slots than links extending from the respective network node.

32. A wireless interconnected network comprising:
a plurality of network nodes communicating wirelessly with each other; and
a network management unit configured to associate time slots with links between the plurality of network nodes;
wherein the plurality of network nodes and the network management unit are configured to transmit data by:
aa) setting a predetermined number of successive hop levels for the data transmission between the source node and the target node of the plurality of network nodes, a plurality of the network nodes via which data is routable from the source node to the target node being provided for each hop level;
a) setting a main path having one network node per hop level and corresponding links between the network nodes of adjacent hop levels from the source node to the target node;
b) setting each of a number of alternative network nodes of the plurality of network nodes, which do not belong to the main path, from the plurality of network nodes of respective hop levels for the hop levels between source nodes and targets node, a respective alternative network node being associated with an alternative link from the network node of the main path in a preceding hop level to the respective alternative network node and being associated with an alternative link from the respective alternative network node to the network node of the main path in the next hop level; and
c) associating the links of the main path and the alternative links with the time slots such that an alternative link extending from a respective network node receives a temporally later time slot than a link of the main path extending from the respective network node and such that links entering a respective network node receive temporally earlier time slots than links extending from the respective network node.
